(19) United States
(12) Patent Application Publication
(10) Pub. No.: US 2011/0232583 A1
(43) Pub. Date: Sep. 29, 2011

(54) Holder for Treat-dispensing Pet Toy

(76) Inventor: Nancy Yamin, Eugene, OR (US)

(21) Appl. No.: 13/070,679

(22) Filed: Mar. 24, 2011

Related U.S. Application Data
(60) Provisional application No. 61/340,939, filed on Mar. 24, 2010.

(51) Int. Cl. A01K 29/00

(52) U.S. Cl. 119/710

(57) ABSTRACT

A non-consumable pet toy is described, having the capability of removably holding at least one treat-dispensing pet toy and may optionally include cavities or openings to hold treats. A pet can remove the treat-dispensing pet toy to gain access to the treats therein. The toy provides mental and physical stimulation for the pet.

### CROSS-REFERENCE TO RELATED APPLICATION

This application claims priority under 35 U.S.C. §119(e) to U.S. provisional patent application No. 61/340,939, filed Mar. 24, 2010, which is incorporated herein by reference in its entirety.

### BACKGROUND OF THE INVENTION

Non-consumable pet toys having a chamber or cavity containing edible treats provide many benefits for animals such as pet dogs and cats. These benefits include but are not limited to mental stimulation, physical activity, relieving boredom, providing a job for the animal, slowing down the rate at which food is consumed, and enjoyment. Mentally stimulating pet toys include those described in U.S. Pat. No. 7,806,086. This invention adds a dimension to the already popular treat-dispensing pet toys (such as described in U.S. Pat. Nos. 7,278,374 and 7,600,488), because the pet is required to mentally and physically determine how to remove the treat-dispensing pet toy from a holder prior to having access to the treats.

### SUMMARY OF THE INVENTION

This invention embodies holder devices for removably holding treat-dispensing pet toys, and typically comprises a solid piece of a non-consumable material provided with one or more indentations that fixedly but removably hold the one or more treat-dispensing pet toys. The indentations hold the treat-dispensing pet toys securely enough such that they cannot become disengaged or fall out under the force of gravity if the device is oriented in any direction, but the animal is able to disengage or extract them from the holder by pulling with the mouth or pushing or pulling with the paws or any other part of the body. The indentations in the holder optionally may be large enough to hold loose edible treats under the secured treat-dispensing pet toy. The holder optionally has one or more smaller cavities to hold individual pet treats in various different locations on the holder. These smaller cavities are nooks and crannies located any place in or on the holder and hold treats the pet can search for and disengage or extract independently of removing a treat-dispensing pet toy. These smaller cavities are optionally partially covered or removably covered with an integral flap, to increase the challenge of finding them.

In another embodiment, the holder comprises one or more protuberances that securely but removably hold a treat-dispensing pet toy. In this embodiment, the protuberance providing the means of removable attachment to the holder. The shape of the protuberance is such that it fits into an opening normally present in or on the treat-dispensing pet toy, such as the entrance channel to the treat-filled cavity, and by friction or a bulbous end, by way of non-limiting example, the protuberance holds the treat-dispensing toy to prevent disengagement by the force of gravity, but a pet can disengage the treat-dispensing pet toy by pulling with the mouth, paws or other body part. In this embodiment, the holder can optionally comprise smaller cavities to hold individual pet treats independent of those in the one or more treat-dispensing pet toy.

In some embodiments, the treat-dispensing pet toy has on its surface an opening to a channel that leads to the treat-holding chamber. In some embodiments, the opening is blocked or located within the indentation when the treat-dispensing pet toy is attached to the holder. In certain such embodiments, treats can dislodge from the filled treat-dispensing pet toy and fall into the indentation, as described above. In other embodiments, the opening is not blocked by or located within the indentation on the holder, but the pet cannot easily manipulate the treat-dispensing pet toy to gain access to the treats inside it without first disengaging the treat-dispensing pet toy from the holder.

Thus, in one aspect of the invention, a holder is provided for one or more treat-dispensing pet toys having a treat-retaining chamber and a retainable member capable of being fixedly but removably retained in said holder, said treat-dispensing pet toy having means for being manipulated, grasped or pulled by the actions of an animal or human from said retaining means; said holder comprising a substrate having one or more indentations therein, each of said one or more indentations having means for fixedly but removably retaining in said holder said retainable member of said at least one treat-dispensing pet toy.

In a further aspect, the holder further comprises one or more cavities capable of holding pet treats. The one or more cavities are optionally covered with a flap.

In another aspect, the retainable member of the treat-dispensing pet toy comprises an opening that extends between the treat-retaining chamber and an outer surface. In other aspects, the retainable member does not comprise an opening that extends between the treat-retaining chamber and said outer surface. In certain aspects, retaining means comprises said indentation has a complementary shape of said retainable member, and said retainable member is retained in said indentation by contact of said retainable member with said indentation. In other aspects, retaining means comprises an indentation larger than said retainable member, and a constriction at the point of contact between said indentation and said holder. In certain aspects, the constriction is an extension of the holder. In other aspects, the constriction is provided by a separate insert device.

In another aspect, a holder for one or more treat-dispensing pet toys is provided, each of said treat-dispensing pet toy comprising a treat-retaining chamber and a retainable member capable of being fixedly but removably retained by retaining means on said holder, said treat-dispensing pet toy having means for being manipulated, grasped or pulled by the actions of an animal or human from said retaining means; said holder comprising a substrate having one or more protuberances thereon, each of said one or more protuberances having means for fixedly but removably retaining on said holder said retainable member of said at least one treat-dispensing pet toy. In a further aspect, the holder further comprises one or more cavities capable of holding pet treats. The one or more cavities are optionally covered with a flap.

In another aspect, the retainable member comprises on its surface an opening to a channel that extends from the outer surface to the treat-retaining chamber. In other aspects, the retainable member does not comprise the opening that extends between said treat-retaining chamber and said outer surface, said retainable member comprising means for being retained on said protuberance. In some aspects, the protuberance has a bulbous end.

In the foregoing aspects, the holder can be comprised of neoprene, polypropylene, polyethylene, high-density polyethylene, silicone or polyurethane.

In a further aspect of the invention, a holder may have one or more indentations or one or more protuberances, or independently, one or more of each of an indentation or a protuberance, in any combination. Furthermore, any of said forgoing combination can have one or more cavities, optionally flap covered, as described herein.

In a further aspect, a method for providing mental stimulation, physical activity, relieving boredom, providing a job for an animal, slowing down the rate at which food is consumed, enjoyment, or any combination of the foregoing, comprising providing to a pet a device as described in any of the foregoing aspects or embodiments, in combination with at least one treat-dispensing pet toy engaged in at least one indentation therein or protuberance thereon, and wherein at least one treat is provided in at least one said treat-dispensing pet toy. In the foregoing aspects, the force necessary to remove said at least one treat-dispensing pet toy from said holder is provided by a pet's mouth, paws, other body part, or the combination thereof.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

FIG. 1 shows two exemplary holders of the invention. The holder shown in Example 1 comprises four indentations for fixedly but removably holding up to four treat-dispensing pet toys. The holder depicted in Example 2 has three indentations to hold up to three treat-dispensing pet toys;

FIG. 2 shows more detail of Example 2 in FIG. 1; and

FIG. 3 is a transverse section through the plane of the holder with treat-dispensing pet toys removed, partially inserted, and inserted into the corresponding indentations.

### DETAILED DESCRIPTION OF THE INVENTION

This invention is a pet toy and is best suited for dogs and cats, but can be modified for almost any animal. It employs for its use one or more treat-dispensing pet toys such as but not limited to those described in U.S. Pat. Nos. 7,278,374 and 7,600,488, but adds at least one additional dimension to the pet's activity of using the aforementioned treat-dispensing pet toy, by providing a holder or substrate in which one or more of the treat-dispensing pet toys are removably attached, such that the pet must use its mental and physical faculties to disengage, dislodge, extract or remove the treat-dispensing pet toy before gaining access to the treats therein (and then, optionally the additional challenge of extracting the treat from the disengaged treat-dispensing pet toy).

In general, a holder is provided for one or more treat-dispensing pet toys, each treat-dispensing pet toy comprising a treat-retaining chamber and a retainable member, said holder comprising a substrate having one or more retaining means for fixedly but removably retaining in or on said holder the retainable member of said at least one treat-dispensing pet toy. As will be described in more detail below, the retaining means can comprise an indentation within the holder, or a protuberance on the holder, or combinations thereof. The retainable member portion of the treat-dispensing pet toy is retained in or on the holder, but the treat-dispensing pet toy is removed from the holder by actions of a pet, to gain access to the treats therein.

In some embodiments, the point of access (orifice or opening) on the surface of the treat-dispensing pet toy to a channel that leads to the treat-holding chamber is blocked when the treat-dispensing pet toy is attached to the holder. In certain such embodiments, treats can dislodge from the filled treat-dispensing pet toy and fall into the indentation, as described above. In other embodiments, the opening is not blocked by the holder, but the pet cannot easily manipulate the treat-dispensing pet toy to gain access to the treats inside it without first disengaging the treat-dispensing pet toy from the holder.

The inventive holder for the one or more treat-dispensing pet toys can hold any number and size or shape of treat-dispensing pet toys, and may also have individual treats hidden in exposed or flap-covered cavities accessible from the surface of the holder. Treats may also be placed in the indentation under the treat-dispensing pet toy before the treat-dispensing pet toy is placed in the holder. Treats may also fall into this space while in the process of placing the treat-dispensing pet toy into the indentation in the holder or during handling or play by the pet.

When the pet plays with the holder, the pet may engage in at least one or any combination of the following activities:
Disengage or extract the one or more treat-dispensing pet toys to find which treat-dispensing pet toys hold treats and/or food;
Search for an extra treat that has been placed under the treat-dispensing pet toy after it is extracted;
Consume the treats from the treat-dispensing pet toy and any challenges associated therewith; or
Find hidden treats in optionally provided smaller cavities, optionally flap-covered, at various locations on the surface of the holder, and consume these treats.

In one embodiment, the pet's meal may be divided among the treat-dispensing pet toys, optionally loose in indentations and optionally present in optionally provided cavities, providing fun and mental stimulation while the pet is consuming his meal, or it can be used with treats, for example, between regular meals. Herein, food and treats and edible treats are used synonymously with regard to the content of the treat-dispensing pet toy, the optional cavities on the holder, or both. Typically, a holder of the invention comprises at least one indentation to fixedly but removably hold or grasp a treat-dispensing pet toy, but can have any number of the former and from none to any number of additional cavities on the surface to hold treats. None, some, or all of these additional cavities may have a flap or partial covering on or over the cavity, optionally a flexible covering, to additionally hide direct access of the pet to the treat, requiring the pet to mentally and physically find or uncover the treat by opening the flap or reaching behind it. The flap is typically an integral part of the holder; i.e., fabricated from the same material or permanently attached, such that it cannot be separated from the holder.

Fixedly or firmly as use herein means that the treat-dispensing pet toy cannot become dislodged from or fall out of the indentation by gravity when the loaded holder is turned in any direction. Depending on the material used for the holder, the manufacturing process, the flexibility of the holder material, one part or member of the treat-dispensing pet toy may fit loosely (but fixedly) within the indentation, or it may be held snugly, or any firmness there between. Such considerations also depend on the shape and material the treat-dispensing pet toy is fabricated from, and the best means to secure it to the holder for ease in placement by the pet's human sponsor, remaining in place when provided to the pet and during unintentional movement, turning over or around, etc., but being removable upon the pet's direct action on that particular treat-dispensing pet toy. The ease in removal can be modified by changing the shape of the indentation or the material used in the holder's construction, or other means. The invention is not so limited as to the means for securely but removably holding the treat-dispensing pet toy, and the means to achieve this will be readily apparent to the skilled artisan. The various methods and constructions described herein for fixedly but removably holding the treat-dispensing pet toy are generally referred to as retaining means. The part or portion of the treat-dispensing pet toy retained in or on the holder is referred to herein as the retainable member.

This pet toy is a holder device for removably holding at least one treat-dispensing pet toy, typically comprises a solid piece or block of a non-consumable material provided with one or more indentations that fixedly but removably hold or grasp the one or more treat-dispensing pet toys. The holder is typically much larger than any one treat-dispensing pet toy and typically is of a substantial weight such that it remains on the floor or ground or other horizontal surface while the pet is attempting to remove the one or more treat-dispensing pet toys. The thickness of the holder is such that the indentations from one or more surfaces are deep enough to hold a graspable part of the treat-dispensing pet toy; such toys often comprise at least one bulbous end for which a corresponding indentation in the surface of the holder is provided to grasp and hold against the force of gravity from any direction, yet be removed by force by the pet. The holder can be fabricated from any material suitable for use with pets, and can be formed to grasp the one or more treat-dispensing pet toys and removal by the mouth or paws or other body part of the pet. Some examples of possibilities for shapes of the holder are a solid rectangular mat, a block, the shape of a log or a tree, a shape of a field of grass, an assortment of fruit, or any other shape. Designing the holder to match the style of treat-dispensing pet toy that it will hold leaves many possibilities.

Generally, the holder embodied herein is significantly larger in size than any one treat-dispensing pet toy, and generally weighs at least 2 times the weight of the treat-dispensing pet toy, and as much as 100 times the weight or more. In one embodiment wherein the treat-dispensing pet toys are 5-10 inches in length and weigh 100-500 grams, the holder is about 1 kg in weight and about 30 by 30 by 10 cm high. The relative dimensions can be seen in the accompanying figures but theses are merely illustrative and non-limiting. In other embodiments, the holder comprises projections or surface locations without indentations, such that the pet can hold the holder with one or more paws, or between its paws, while attempting to extract the treat-dispensing pet toy with its mouth.

By way of non-limiting example, the holder can be fabricated from neoprene, polypropylene, polyethylene, high-density polyethylene, silicone, polyurethane, or another non-toxic elastomeric. Other materials such as wood and cardboard are also embodied, or combinations of materials, provided that means for fixedly but removably holding one or more treat-dispensing pet toys is present. The holder will be mainly rigid, but thinner areas may have flexibility. The dimensions and weight of the holder will be selected based on the number of indentations or protuberances provided for the one or more treat-dispensing pet toys and the number of optional, optionally flap-covered cavities for holding treats. The indentations, protuberances and/or cavities can be provided on any surface of the holder, typically provided such that during the filling, placement and initial use of the holder, the treats in the cavities without flaps are held within the one or more cavities by gravity. The size, dimensions and weight of the holder may be such that the pet can readily take the holder from a human's hand or from the floor, for example, and turn or flip it on any side to gain access to the treat-dispensing pet toys and cavities on the various surfaces. In other embodiments, the holder may be designed to remain in place on the floor, with all of the indentation(s) and optional cavities on one (a top) surface or a top surface and sides, but not a bottom surface for maintaining on the floor. In some cases, the holder may be mounted or mounting means provided for maintaining its location during interaction by the pet.

The indentations in the holder that provide retaining means to firmly but removably hold or grasp a treat-dispensing pet toy can be molded to firmly grasp a portion or member of the treat-dispensing pet toy, i.e., be a concavity of matching shape to the treat-dispensing pet toy shape at the site of engagement, or the indentation can be a conical, cylindrical or parallelepiped-shaped cavity larger in shape than the portion of the treat-dispensing pet toy held therein, but with a narrowed lip, constriction or restriction at the surface of the holder such that one end of the treat-dispensing pet toy is loosely held in the indentation but cannot fall out under the force of gravity. The ease in which the pet can remove the treat-dispensing pet toy can then be provided by the diameter of the lip or restriction, and/or the material from which the holder or that portion of the holder is fabricated. As noted above, firmly does not necessary mean unmovably held, but simply that the treat-dispensing pet toy cannot become separated from the holder without force greater than gravity. For training purposes and for the purpose of increasing the difficulty or challenge, holders may be available with various forces required for the pet to remove the treat-dispensing pet toys. In other embodiments, indentation diameter-reducing or volume-reducing inserts may be provided, such that initially the indentations are larger allowing the treat-dispensing pet toys to be removed easily. Once the pet understands the task of removing them to gain access to treats, such inserts can be placed in the indentation(s) to decrease the size or diameter of the indentation to more firmly grasp the portion of the treat-dispensing pet toy therein. In other embodiments the lip, constriction or restriction of the holder at its surface for removal of the treat-dispensing pet toy can be varied by use or replacement of an insert to achieve the same goals. These are merely non-limiting examples of variations on the invention herein and other similar variations are well within the scope intended herein.

While typically the holder will be manufactured as a single, integral unit, optionally the holder can be manufactured to be assembled by the pet's sponsor (but not disassemblable by the pet) into the working holder, such that the indentations and cavities can be easily cleaned. In one embodiment, the holder is made of at least two units, wherein the seam between the two units runs within the indentations, so that when apart the indentations are split open for easy access. In another embodiment, the separation of the holder into units along the indentations allows for the user to modify the physical dimensions of the holder and the indentations, for example, if during long use the material at the indentations is eroded and the treat-containing pet toys are not so tightly held in place. By removing a small amount of interface between the units, the indentations can be made smaller. The units may be held by clamps, interlocking interior protrusions and matching indentations, or any other means that keeps the holder intact during pet play.

As noted above, at least one treat-dispensing pet toy is used in the play activity associated with the invention, but the treat-dispensing pet toy is not necessarily part of the invention. Each of said treat-dispensing pet toy typically has at least one treat-retaining chamber and typically but not necessarily an opening that extends between the treat-retaining chamber and an outer surface of the treat-dispensing pet toy. As will be described below, typically the treat-dispensing pet toys have an elongate shape that includes a portion or part, herein called a retainable member, that is capable of being fixedly but removably retained in or on the inventive holder, and another part of the treat-dispensing pet toy having means for being manipulated, grasped or pulled by the actions of an animal or human. Means for being manipulated, grasped of pulled refers to the presence on the treat-dispensing pet toy for contact with a hand, paw, mouth or other body part of a human or animal by which the treat-dispensing pet toy can be inserted into the indentation on the holder, and subsequently removed. The means for being manipulated may also refer to the retainable member thereon mentioned above, should the retainable member be capable of being retained in the indentation and also provide means for manipulation and extraction. In other embodiments, the means for being manipulated may be a different location on the treat-dispensing pet toy; for example, an elongate treat-dispensing pet toy may have one end associated with the indentation, and the other end available for manipulation. In this manner, the treat-dispensing pet toy (optionally containing treats) can be reversibly bound to the holder by a person, the bound treat-dispensing pet toy being fixedly retained on the holder, but can be removed by pull, such as when grasped by a pet's teeth, mouth, paws or other body part, and manipulated or pulled from said retention. In other embodiments, the treat-dispensing pet toy is not necessarily elongated but has a member that can be bound to the holder. In some embodiments the member is the entirety of the treat-dispensing pet toy, for example, when protuberances or pegs on the holder are used to fixedly but removably hold it, as described herein.

Non-limiting examples of such treat-dispensing pet toys are described in U.S. Pat. Nos. 2,086,631; 6,237,538; 6,289,846; 6,439,166; 6,470,830; 6,546,896; 6,688,258; 7,278,374; and 7600488. The inventive holder is typically manufactured for use with particular type(s) of treat-dispensing pet toy, such that the indentations are suitable for fixedly but removably holding the one or more treat-dispensing pet toy of particular dimensions at the holding site. Inserts or other adapters can be provided for matching particular types or shapes of treat-dispensing pet toys with a universal holder of the invention. Other means for matching the treat-dispensing pet toy with the indentations of the inventive holder will be readily apparent to the skilled artisan and such variations on the embodiments herein fully embraced by the teachings herein. While typically a treat-dispensing pet toy comprises a treat-retaining chamber and an opening that extends between said treat-retaining chamber and an outer surface of said treat-dispensing pet toy, the embodiments herein are not so limiting and any other type of treat-dispensing pet toy can be used herein, such as one wherein the pet must separate parts of the treat-dispensing pet toy, once removed from the holder, in order to access the treat-containing chamber, or variations thereof.

In another embodiment, the holder comprises treat-dispensing pet toy retaining means provided by one or more protuberances or pegs extending from its surface that securely but removably hold a treat-dispensing pet toy. In this embodiment, the protuberance providing the means of removable attachment to the holder. The shape of the protuberance is such that it fits into an indentation normally present in or on the treat-dispensing pet toy, such as the entrance channel to the treat-filled cavity, and by friction or a bulbous end, by way of non-limiting example, the protuberance holds the treat-dispensing toy to prevent disengagement by the force of gravity, but a pet can disengage the treat-dispensing pet toy by pulling with the mouth. For example, one embodiment of the treat-dispensing pet toy described in U.S. Pat. No. 7,600,488 comprises a barbell-shaped device with an opening at one or both ends for access to the treat-holding chamber. The holder of the present invention can, in one embodiment, comprise one or more protuberances, each with a bulbous end or tip that fits into the opening at an end of the aforementioned treat-dispensing pet toy, which removably holds the latter but a pet can dislodge the treat-dispensing pet toy from the protuberance by pulling. In this embodiment, the holder can optionally comprise smaller cavities to hold individual pet treats independent of those in the one or more treat-dispensing pet toy. In a further embodiment, a holder can have one or more indentations and one or more protuberances, either with one or more cavities optionally covered by flaps. Embodiments described above with regard to the construction, operation, and other features of a holder with the indentations to hold treat-dispensing pet toys are applicable to the holder with protuberances, or a holder with both at least one indentation and at least one protuberance.

Thus, the holder herein must have at least one indentation or protuberance, and optionally in addition one or more indentations, one or more protuberances, or any combination thereof.

In another embodiment of the holder, one or more indentations of one or more dimensions can be provided to accommodate treat-dispensing pet toys of different dimensions. In another embodiment, the holder can be provided with user selectable but fixable mountable adapters that can be selected by the user to match the dimensions of the treat-dispensing pet toy(s) to be used with the holder. These adapters should not be removable by the pet.

As mentioned above, in some embodiments, the point of access (orifice or opening) on the treat-dispensing pet toy to the edible treat chamber is blocked when the treat-dispensing pet toy is attached to the holder, whether attachment utilizes indentations or protuberances. In certain such embodiments utilizing indentations to grasp the treat-dispensing pet toy, treats can dislodge from the filled treat-dispensing pet toy and fall into the indentation, as described above. In other embodiments, the orifice is not blocked by the holder when attached, whether by means of an indentation or protuberance, but the pet cannot easily manipulate the treat-dispensing pet toy to gain access to the treats inside it without first disengaging the treat-dispensing pet toy from the holder.

The indentations hold the treat-dispending pet toys with adequate force or construction or restriction at least one point on the treat-dispensing pet toy such that they cannot fall out by the force of gravity, but the pet is able to extract them from the holder by pulling with the mouth or pushing or pulling with the paws. The holder can be manufactured with indentations for different grasping strengths of the intended breed of pet. The indentations in the holder optionally may be large enough to hold loose treats under the treat-dispensing pet toy. In one example, the indentation is a hollow in the surface of the holder in the shape of a pyramid with a square top smaller than the square base, where the square smaller top corresponds with the surface of the holder and the bottom of the pyramid with the bottom of the hollow. A treat-containing pet toy with a spherical bulbous end of slightly larger diameter than the square top of the pyramid can be pushed into the indentation having slightly flexible walls, remaining loose but fixed within the cavity until forcibly extracted by pull. In other embodiments, the treat-containing pet toys can be inserted by flexing the holder such that an indentation during flexure can enlarge the opening to the indentation. In other embodiments, the indentation may extend to a wall of the holder that is perpendicular to the surface from which the treat-dispensing pet toy is removed and form another access point for inserting the treat-dispensing pet toy into the holder. In such a case, the treat-dispensing pet toy can be guided into the indentation by inserting into access point on the perpendicular wall and sliding it into its operation position.

The holder optionally has one or more smaller cavities to hold individual pet treats in various different locations on the holder. These smaller cavities are nooks and crannies located any place in or on the holder and hold treats the pet can search for and extract independently of removing a treat-dispensing pet toy. These smaller cavities are optionally removably covered with a flap, to increase the challenge of finding them. These optional cavities provide additional mental and physical challenges.

The indentations in the holder that hold the treat-dispensing pet toys may be shaped and molded to hold different size and/or shaped toys or the indentations may be different sizes to accommodate different size treat-dispensing pet toys. These indentations may be on one side of the holder or on any/all sides of the holder. One example is wherein the larger indentations on one side of the holder and smaller indentations on the other side of the holder to accommodate a different size treat-dispensing pet toy on either side of the holder; one side is used at each session with the pet. In another embodiment, one surface of the holder has indentations from which treat-dispensing pet toys are easier to remove by the pet, and the other side indentations from which extraction is harder, for the same type of treat-dispensing pet toy. Another example is wherein the indentations are conical or tapered so that many different sizes of treat-dispensing pet toys may fit in the same indentation, depending on the depth from the surface and the force applied for attachment.

The cavities in the holder are small openings on any side of the holder and may or may not be concealed by a covering of material. The flap may be an integral part of the holder that partially blocks the opening from the holder surface to the cavity. In other embodiments the flap may be partially attached to the holder such that the pet can push in or pull open the flap to gain access to the contents. The cavities are designed to hold a treat or a piece of food.

In another embodiment, the holder comprises one or more protuberances that securely but removably hold a treat-dispensing pet toy. In this embodiment, the protuberance providing the means of removable attachment to the holder. The shape of the protuberance is such that it fits into an indentation normally present in or on the treat-dispensing pet toy, such as the entrance channel to the treat-filled cavity, and by friction or a bulbous end, by way of non-limiting example, the protuberance holds the treat-dispensing toy to prevent disengagement by the force of gravity, but a pet can disengage the treat-dispensing pet toy by pulling with the mouth. In this embodiment, the holder can optionally comprise smaller cavities to hold individual pet treats independent of those in the one or more treat-dispensing pet toy.

In the use of a holder of the invention having at least one indentation, at least one treat-dispensing pet toy is optionally filled with a treat, and the treat-dispensing pet toy removably affixed to the holder by inserting into the corresponding indentation. As mentioned above the indentation may additionally accommodate a loose treat such that when the pet removes the treat-dispensing pet toy, a treat is available within the indentation, for example, to reward the pet immediately for removing the treat-dispensing pet toy. Then the pet will pay attention to the removed treat-dispensing pet toy to gain access to the treats therein. The loose treat may be placed in the indentation before the treat-dispensing pet toy is inserted into the indentation, or the treat may come out of the treat-dispensing pet toy and into the additional space in the indentation, based on the orientation of the cavity of the treat-dispensing pet toy with the indentation of the holder. As noted above, before use, one or more of the provided cavities may also be loaded with treats. In addition, one or more of the treat-dispensing pet toys may be loaded with treats; some affixed treat-dispensing pet toys may not contain treats. The pet will be additionally challenged to identify which treat-dispensing pet toys and optionally present cavities contain treats and which do not.

In the use of a holder of the invention with at least one protuberance, at least one treat-dispensing pet toy is optionally filled with a treat, and the treat-dispensing pet toy removably affixed to the holder by attaching to a protuberance. As noted above, before use, one or more of the provided cavities may also be loaded with treats. In addition, one or more of the treat-dispensing pet toys may be loaded with treats; some affixed treat-dispensing pet toys may not contain treats. The pet will be additionally challenged to identify which treat-dispensing pet toys and optionally present cavities contain treats and which do not.

In addition to the uses mentioned above, the invention may be used to measure the intelligence and learning rate of a pet, and to study how pets learn. The duration of time required for a pet to successfully access the one or more treats in the one or more treat-dispensing pet toys may be used, over time, to gauge the acquisition of skills and knowledge. Different color or texture treat-dispensing pet toys can be used together to determine preferences. These few examples are merely illustrative and non-limiting as to the additional utilities of the embodiments of the invention.

The following examples are presented in order to more fully illustrate the preferred embodiments of the invention. They should in no way be construed, however, as limiting the broad scope of the invention.

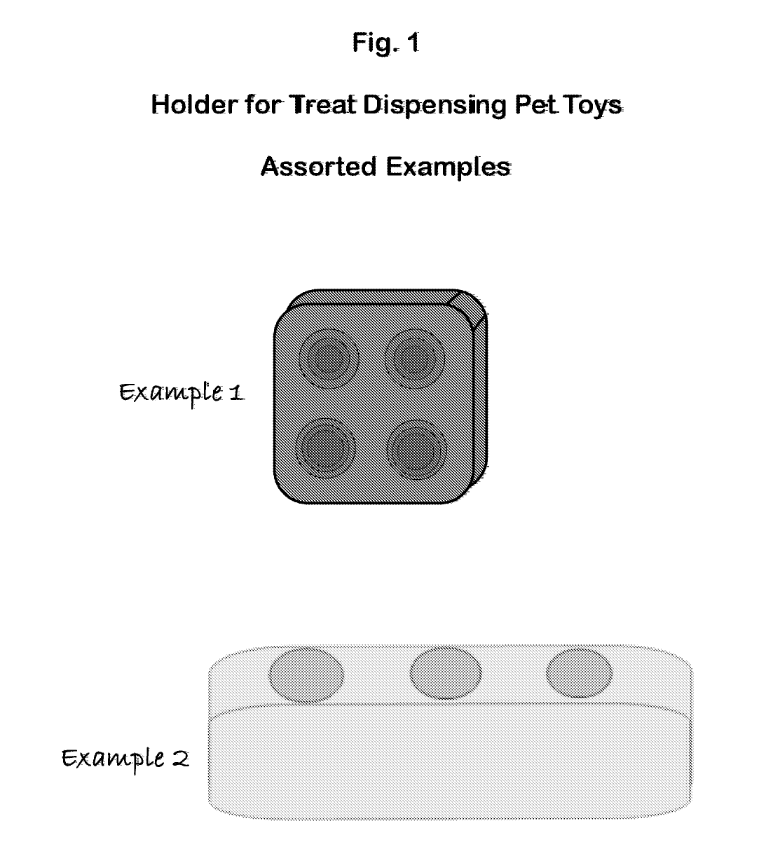

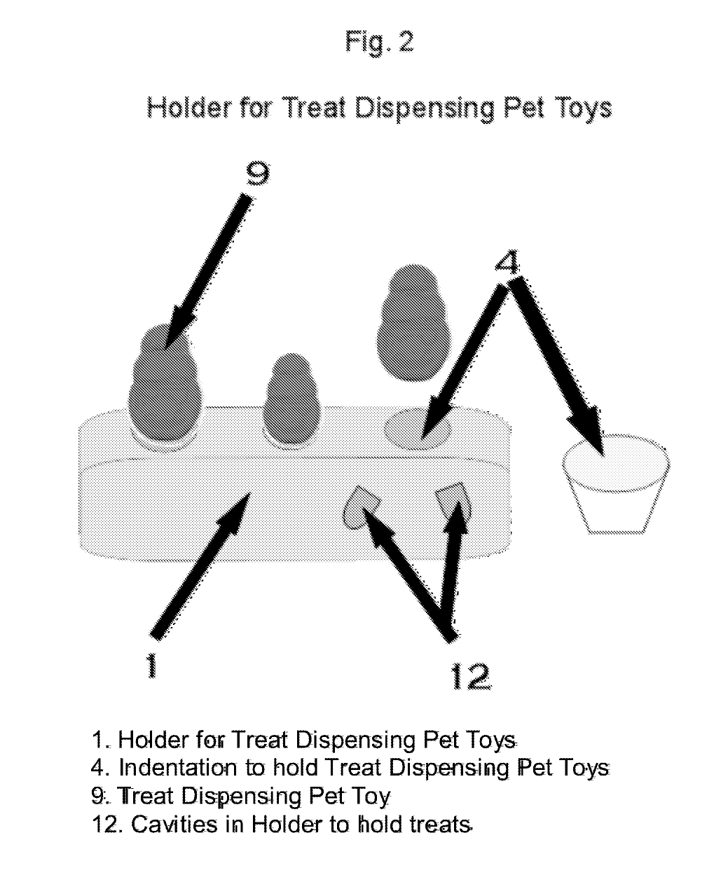

FIG. 1 shows two exemplary holders of the invention. Example 1 comprises four indentations for fixedly but removably holding up to four treat-dispensing pet toys. Example two has three indentations to hold up to three treat-dispensing pet toys. FIG. 2 shows more detail of Example 2 of FIG. 1. In the drawings, the index numerals refer to the following components: holder 1, surface of holder 1 having one or more indentations 4 for treat-dispensing pet toys 9. Treat-dispensing pet toys 9 optionally have one or more treats therein. In addition to at least one indentation 4, holder 1 may have one or more cavities 12 as additional locations for providing one or more treat. Indentation 4 may comprise an additional cavity there within to accommodate additional loose treats.

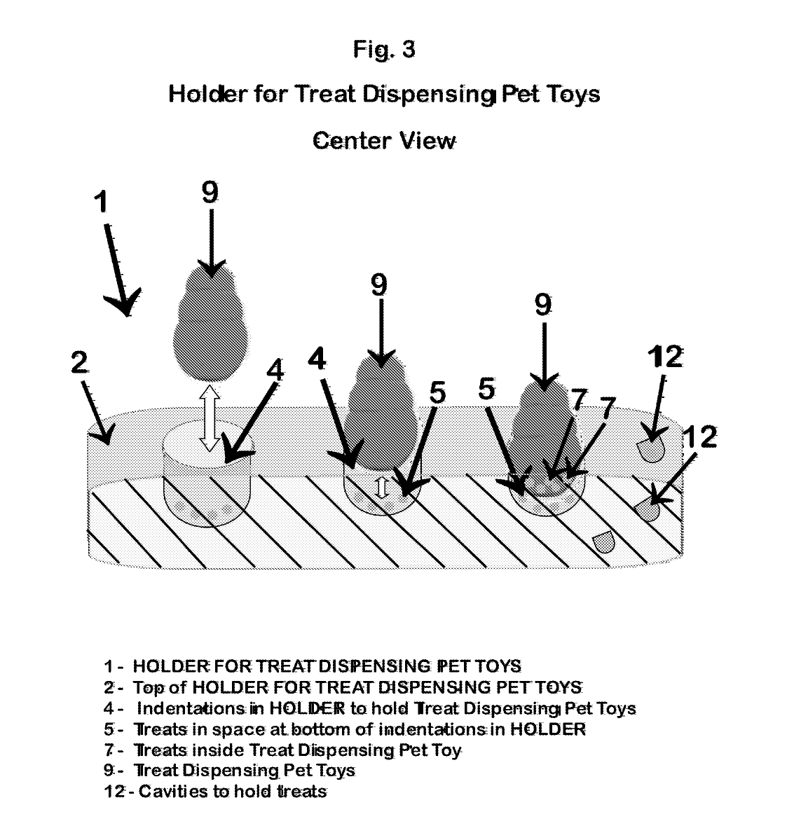

FIG. 3 illustrates details in holder 1 of FIG. 2 for treat-dispensing pet toys 9 with a center view. Holder 1 is constructed of a non-consumable, resilient or flexible material. Holder 1 is, for example, a unitary molded piece of plastic or resin with one or more indentations 4, each indentation 4 of a dimension to fixedly but removably hold a treat-dispensing pet toy 9. The indentation 4 is provided, for example as a conical or bulbous concavity to snugly hold an end of treat-dispensing pet toy 9. The indentations may be molded with an inside rim if needed so that each treat-dispensing pet toy 9 fits snugly yet is able to be extracted by the pet with the mouth or the paws. Each indentation 4 may be the same or different, to accommodate the same or different dimensions of treat-dispensing pet toy 9. The indentation 4 may be deep enough to allow extra space at the bottom or molded in such a way that there is an extra indent at the bottom to allow for one or more loose treats 5 below the treat-dispensing pet toys 9. Once the treat-dispensing pet toys 9 are extracted from holder 1, the pet can access the extra treats 5 as well as treats inside 7 the treat-dispensing pet toy 9. The treat-dispensing pet toys 9 also contain treats residing inside 7 therein for the pet to consume. Cavities 12 are optionally present small openings placed in one or more various locations any place on the holder. The cavities 12 may have a flap of material partially covering the opening of the cavity or are molded in such a way that a treat stays in place but that the pet can extract them with the mouth or paws.

In other embodiments, the holder is not necessarily a solid block but is fabricated with chambers and supporting internal structures and walls to maintain the overall shape, and indentations or protuberances accommodating the one or more treat-dispensing pet toys as described above.

In one example, a neoprene block 8 inches by 5 inches by 2 inches thick has, in one of the 8×5 inch surfaces (top of holder 2), five indentations therein, arranged in the pattern like the number 5 on a die or end of a domino, the indentations of a size in which the larger end of a treat-dispensing pet toy can be fixedly inserted snugly, by hand. A small amount of water or other pet-safe lubricant can be used to insert the toy. Some but not all of the treat-dispensing pet toys are loaded with treats.

In one example, a treat-dispensing pet toy has a shape similar to that shown as index number 9 in FIG. 2. In a non-limiting example, the treat-dispensing pet toy is 4.5 inch tall, with a wider base of 2.5 inch diameter (bottom) and 1.75 inch diameter at the narrower top. The opening to the cavity containing treats is at the center of the bottom. The holder comprises an indentation in a surface the shape of a cube 2.75 inches on a side, with a rim at the surface providing an opening of 2.25 inches in diameter. The holder is fabricated from silicone elastomer such that the treat-dispensing pet toy's larger 2.5 inch diameter end can be forced through the 2.25 inch diameter rim and into the indentation, such that the treat-dispensing pet toy cannot fall out of the indentation by gravity but must be pulled out by force.

Thus, in one embodiment, a device for fixedly but removably holding at least one treat-dispensing pet toy is provided, the device comprising at least one indentation for holding said at least one treat-dispensing pet toy. In another embodiment, the force necessary to remove the at least one treat-dispensing pet toy from said device is provided by a pet's mouth, paws, or the combination thereof. In another embodiment, the device is larger than the at least one treat-dispensing pet toy. In another embodiment, at least one protuberance is provided for fixedly but removably holding said at least one treat-dispensing pet toy.

In another embodiment, a method is provided for mental stimulation, physical activity, relieving boredom, providing a job for an animal, slowing down the rate at which food is consumed, enjoyment, feeding, or any combination of the foregoing, by a pet animal, comprising providing to a pet a device as described above in combination with at least one treat-dispensing pet toy engaged in at least one indentation therein, and wherein at least one treat is provided in at least one said treat-dispensing pet toy.

In another embodiment, a holder as described herein is provided together with at least one treat-dispensing pet toy retained thereto by retaining means as described herein. Thus, one embodiment comprises a holder as described herein in combination with at least one treat-dispensing pet toy, wherein the treat-dispensing pet toy is fixedly but removably retained in at least one indentation in, or on at least one protuberance on, the holder.

Having described preferred embodiments of the invention with reference to the accompanying drawings, it is to be understood that the invention is not limited to the precise embodiments, and that various changes and modifications may be effected therein by those skilled in the art without departing from the scope or spirit of the invention.

What is claimed is:

1. A holder for one or more treat-dispensing pet toys, each treat-dispensing pet toy comprising a treat-retaining chamber and a retainable member, said holder comprising a substrate having one or more indentations therein, each of said one or more indentations fixedly but removably retaining in said holder the retainable member of said at least one treat-dispensing pet toy.

2. The holder of claim 1 wherein said holder further comprises one or more cavities capable of holding pet treats.

3. The holder of claim 2 wherein the one or more cavities are optionally covered with a flap.

4. The holder of claim 1 wherein the treat-dispensing pet toy comprises on its outer surface an opening to a channel that extends from the outer surface to the treat-retaining chamber.

5. The holder of claim 4 wherein the retainable member comprises said opening.

6. The holder of claim 4 wherein the retainable member does not comprise said opening.

7. The holder of claim 1 wherein said indentation has a complementary shape of said retainable member, and said retainable member is retained in said indentation by contact of said member with said indentation.

8. The holder of claim 1 wherein said indentation is larger than said retainable member, and said member is retained by a constriction at the point of contact between said indentation and said holder.

9. The holder of claim 1 wherein said constriction is an extension of the holder.

10. The holder of claim 9 wherein said constriction is provided by a separate insert device.

11. The holder of claim 1 comprised of neoprene, polypropylene, polyethylene, high-density polyethylene, silicone or polyurethane.

12. A holder for one or more treat-dispensing pet toys, each treat-dispensing pet toy comprising a treat-retaining chamber and a retainable member, said holder comprising a substrate having one or more protuberances thereon, each of said one or more protuberances fixedly but removably retaining on said holder said retainable member of said at least one treat-dispensing pet toy.

13. The holder of claim 12 wherein said holder further comprises one or more cavities capable of holding pet treats.

14. The holder of claim 13 wherein the one or more cavities are optionally covered with a flap.

15. The holder of claim 12 wherein the treat-dispensing pet toy comprises on its outer surface an opening to a channel that extends from the outer surface to the treat-retaining chamber.

16. The holder of claim 15 wherein the retainable member comprises said opening.

17. The holder of claim 15 wherein the retainable member does not comprise said opening.

18. The holder of claim 11 wherein said protuberance has a bulbous end.

19. The holder of claim 11 comprised of neoprene, polypropylene, polyethylene, high-density polyethylene, silicone or polyurethane.

20. A method for providing mental stimulation, physical activity, relieving boredom, providing a job for an animal, slowing down the rate at which food is consumed, enjoyment, or any combination of the foregoing, comprising providing to a pet the holder of claim 1 in combination with at least one treat-dispensing pet toy engaged in at least one indentation therein, and wherein at least one treat is provided in at least one said treat-dispensing pet toy.

21. A method for providing mental stimulation, physical activity, relieving boredom, providing a job for an animal, slowing down the rate at which food is consumed, enjoyment, or any combination of the foregoing, comprising providing to a pet the holder of claim 12 in combination with at least one treat-dispensing pet toy engaged on at least one protuberance thereon, and wherein at least one treat is provided in at least one said treat-dispensing pet toy.
